(19) United States
(12) Patent Application Publication
(10) Pub. No.: US 2011/0097560 A1
(43) Pub. Date: Apr. 28, 2011

(54) DEVICE HOUSING AND METHOD FOR MAKING THE SAME

(75) Inventor: QIANG WANG, Shenzhen City (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/842,132

(22) Filed: Jul. 23, 2010

(30) Foreign Application Priority Data
Oct. 27, 2009 (CN) 200910308878.0

(51) Int. Cl. B32B 3/10; B32B 15/02; B05D 5/06; B05D 1/32

(52) U.S. Cl. 428/209; 427/256; 427/250; 427/282; 427/210

(57) ABSTRACT

A device housing comprises a transparent substrate, a paint coating, and a metallic coating. The paint coating is formed on portions of one surface of the transparent substrate. The metallic coating is formed on other portions of the surface of the transparent substrate having the paint coating. A method for making the device housing is also described there.

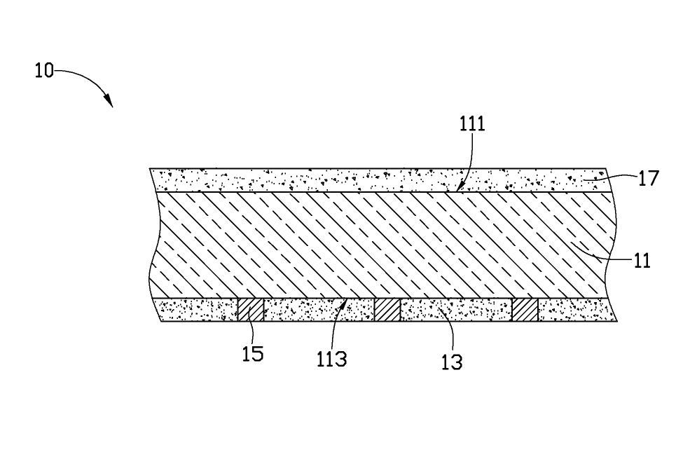

### BACKGROUND

1. Technical Field

The present disclosure relates to a device housing and a method for making the device housing.

2. Description of Related Art

Housings of electronic devices with aesthetically pleasing appearances are more attractive to customers. The housings are commonly made of plastic or metal. These plastic housings are usually covered with paint coatings to present desired colors. However, these paint coatings cannot present a complex decoration, and are easily abraded.

Therefore, there is room for improvement within the art.

### BRIEF DESCRIPTION OF THE FIGURE

Many aspects of the device housing can be better understood with reference to the following FIGURE. The components in the FIGURE are not necessarily drawn to scale, the emphasis instead being placed upon clearly illustrating the principles of the device housing.

The FIGURE is a schematic view of an exemplary embodiment of a device housing.

### DETAILED DESCRIPTION

The FIGURE shows an exemplary embodiment of a device housing 10 including a transparent substrate 11, a paint coating 13, and a metallic coating 15 formed on one surface of the substrate 11, and a protective coating 17 formed on the surface of the transparent substrate 11 opposite to the paint coating 13 and the metallic coating 15. The opposite surface is the surface exposed to the outside environment. The exemplary device housing 10 can be, for example, a housing of a mobile phone, a PDA, a notebook computer, a digital camera, or a game machine.

The transparent substrate 11 can be a molded plastic article. The plastic may be one or more materials selected from a group consisting of polypropylene (PP), polyamide (PA), polycarbonate (PC), polyethylene terephthalate (PET), and polymethyl methacrylate (PMMA). Alternatively, the substrate 11 can be made of glass. The transparent substrate 11 includes an exterior surface 111 and an interior surface 113 opposite to the exterior surface 111.

The paint coating 13 is formed on portions of the interior surface 113 in a desired pattern and in colors according to a predefined design.

The metallic coating 15 is formed on other portions of the interior surface 113. The metallic coating 15 can be applied by a vapor deposition. The material of the metallic coating 15 can be one or a combination of materials selected from a group consisting of aluminum, aluminum alloy, copper, titanium and titanium alloy. The thickness of the metallic coating 15 can be equal to or less than the thickness of the paint coating 13. The metallic coating 15 and the paint coating 13 can be applied to form a mosaic like pattern on the interior surface 113.

The protective coating 17 may be a transparent paint coating formed on the exterior surface 111. The protective coating 17 is used to protect the device housing 10 from abrasion.

Viewed through the transparent protective coating 17, the metallic coating 15 contrasts with the paint coating 13 and presents an aesthetically pleasing appearance. Furthermore, the paint coating 13 and the metallic coating 15 are formed on the interior surface 113 and cannot be abraded, and accordingly can maintain the aesthetic appearance of the device housing 10 over a long period of time.

A method for making the device housing 10 may include the following steps: providing a transparent substrate; painting a paint coating on portions of one surface of the transparent substrate; and forming, on other portions of the surface having the paint coating, a metallic coating.

Specifically, a transparent substrate 11 is provided. The substrate 11 can be made of plastic or glass. The substrate 11 includes an exterior surface 111 and an interior surface 113 opposite to the exterior surface 111.

Prior to applying a paint coating 13 on portions of the interior surface 113 of the transparent substrate 11, other portions may be masked.

Then, any masking may be removed, and once the paint coating 13 is dried it may be masked and a metallic coating 15 is applied on the unpainted portions of the interior surface 113. Forming the metallic coating 15 can be carried out by a vapor deposition.

A transparent protective coating 17 is formed on the exterior surface 111 of the substrate 11 to protect the device housing 10 from abrasion.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

1. A device housing, comprising:
a transparent substrate;
a paint coating formed on portions of one surface of the transparent substrate; and
a metallic coating formed on other portions of the surface of the transparent substrate having the paint coating.

2. The device housing as claimed in claim 1, wherein the paint coating defines a pattern on the surface of the transparent substrate.

3. The device housing as claimed in claim 1, wherein colored paints are used to form the paint coating.

4. The device housing as claimed in claim 1, wherein the metallic coating is formed by vapor deposition.

5. The device housing as claimed in claim 1, wherein the metallic coating is formed with one or a combination of materials selected from a group consisting of aluminum, aluminum alloy, copper, titanium and titanium alloy.

6. The device housing as claimed in claim 1, further comprising a transparent protective coating formed on another surface of the transparent substrate opposite to the surface on which the paint coating and the metallic coating are formed.

7. The device housing as claimed in claim 6, wherein the protective coating is a transparent paint coating.

8. The device housing as claimed in claim 1, wherein the transparent substrate is made of plastic or glass.

9. A method for making a device housing, comprising:
providing a transparent substrate;
painting a paint coating on portions of one surface of the transparent substrate; and
forming, on other portions of the surface having the paint coating, a metallic coating.

10. The method as claimed in claim 9, wherein forming the metallic coating is carried out by a vapor depositing process.

11. The method as claimed in claim 9, further comprising a step of masking the other portions of the surface of the transparent substrate before painting the paint coating.

12. The method as claimed in claim 9, further comprising a step of masking the paint coating before forming the metallic coating.

13. The method as claimed in claim 9, further comprising a step of forming a transparent protective coating on the surface of the transparent substrate opposite to the surface on which the paint coating and the metallic coating are formed.
